(19) United States
(12) Patent Application Publication
(10) Pub. No.: US 2008/0107365 A1
(43) Pub. Date: May 8, 2008

(54) LINEAR ROLLER BEARING

(76) Inventor: Arnold Mueller, Kirchheim/Teck (DE)

Correspondence Address: Striker, Striker & Stenby, 103 East Neck Road, Huntington, NY, 11743, US

(21) Appl. No.: 11/866,501

(22) Filed: Oct. 3, 2007

(30) Foreign Application Priority Data
Nov. 8, 2006 (DE) 10 2006 052 597.3

(51) Int. Cl. F16C 29/06

(52) U.S. Cl. 384/44

(57) ABSTRACT

A linear roller bearing has raceway elements, which are grouped around the central axis of the bearing, include rows of rolling elements distributed around a circle—as viewed in the cross section—and which are essentially parallel to each other and to the central axis of the bearing, the raceway elements being by enclosed in the circumferential direction by at least one connecting piece on at least one longitudinal section such that the raceway elements bear via the outer surface of the longitudinal section against a facing inner surface of the at least one connecting piece. The inner surface and the outer surface are curved biaxially and bear against each other in two dimensions, thereby resulting in a design similar to that of a ball joint.

### CROSS-REFERENCE TO A RELATED APPLICATION

The invention described and claimed hereinbelow is also described in German Patent Application DE 10 2006 052 597.3 filed on Nov. 8, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a linear roller bearing.

A linear roller bearing of the aforementioned type is known (EP 1199485 A1), with which the individual raceway elements are accommodated via their circular arc-shaped outer surfaces in a matching cylindrical inner bore of a connecting piece, which encloses the raceway element structure. The raceway elements are not adjustable. They react to deformations under stress with excess loads, which result in increased local pressure and, therefore, to a shortened service life.

Self-adjusting linear guides (DE 19 49 182 A1) are also known. These linear guides include raceway plates, which are located in closed cages or housing. These raceway plates, which include the carrier raceways for the rolling elements, have supporting surfaces on the side facing away from the carrier raceway, which provide support on an outer connecting piece. These outer surfaces are slanted diagonally, starting from a center—which forms a rocker bearing—toward the ends. The raceway plates may therefore act as rockers and adapt to changes in shape caused by loads imposed by profiles, e.g., shafts, that pass through linear roller bearings of this type. As a result, loads are distributed on the individual roller bearings more evenly than is the case with rigid, non-adjustable linear roller bearings. Similar self-adjusting linear roller bearings are made known in DE 42 10 039 A1. In those cases, the raceway elements have a bulge on their outer surface. The bulge extends toward the ends in the longitudinal direction and in the circumferential direction, and it allows a tilting motion to take place relative to an enclosing connecting piece.

Self-adjusting linear roller bearings of this type have the disadvantage that they are adjustable only to a minimal extent in the longitudinal direction, e.g., by 0.5°. The adjustment capability is limited by the tarnishing of the raceway plates, which are curved only slightly, in the receiving bore of the connecting piece. The raceway plates are often supported on light metal on lines that extend in the longitudinal direction. The large radius of the ball-like shape of the outer surface is designed to reduce the Hertzian contact pressure and thereby prevent plastic deformation of the connecting pieces that are made of light metal. The connecting pieces are still deformed plastically when high loads are applied and impacts occur.

In summary, known linear roller bearings have the disadvantage of reduced service life and running characteristics even when moderate forces are applied if they are unable to adapt to deformations caused by the penetrating profile, e.g., a shaft. Linear roller bearings of this type, the raceway elements of which have a slightly ball-shaped outer surface, have only minimal adjusting capability, in particular when the rows have large cross-sections, and they make it necessary for the bushing to be secured using separate retaining elements. Since highly divergent radii are supported, all bushings have only minimal adjusting capability in the longitudinal and transverse directions, and they have are unable to retain a profile extending through it.

### SUMMARY OF THE INVENTION

The object of the present invention is to design a linear roller bearing of the type described in the preamble such that its raceway elements are self-adjusting across a wide range and may adapt to deformations, e.g., of profiles—e.g., shafts—extending through the bearing, independently of each other, in fact. Simultaneously, the bushing, which is composed of raceway elements of this type, is accommodated in a connecting piece in an axially self-retaining manner.

In keeping with these objects and with others which will become apparent hereinafter, one feature of the present invention resides, briefly stated, in a linear roller bearing, comprising a plurality of raceway elements which are grouped around a central axis of the bearing; rows of rolling elements distributed around a circle, as viewed in a cross-section, and arranged essentially parallel to each other and to said central axis of the bearing; at least one connecting piece which encloses said raceway elements in a circumferential direction on at least one longitudinal section such that said raceway elements bear via an outer surface of said longitudinal section against a facing inner surface of said at least one connecting piece, wherein said inner surface and said outer surface are curved biaxially and bear against each other in two dimensions.

As a result, the individual raceway elements may self-adjust in all directions and independently of each other, so that—if the profiles extending through the linear roller bearing deflect, and if connecting pieces enclosing it become deformed—the load is distributed among the individual rolling elements in an extraordinarily even manner, due to the automatic self-adjustment of the individual raceway elements. The raceway elements are tiltable around their longitudinal axis and their transverse axis in a manner similar to that of a ball joint, and can therefore orient themselves on tracks of stationary guide tracks such that a nearly constant load is placed on the individual rolling elements. At the same time, the form-fit connection of the engaged inner surfaces and outer surfaces ensures an axial hold of the bearing bush within a connecting piece that encloses it, without a separate holding element being required.

Further details and advantages of the present invention result from the description, below.

The complete wording of the claims is not presented above, merely to avoid unnecessary repetitions. Instead, reference is made thereto by referring to the claims, and all of these claim features are considered to have been disclosed here expressly and in a manner that is essential for the present invention. All of the features mentioned n the description above and below, and the features that may be deduced exclusively from the drawing are also further components of the present invention, even if they are not given special emphasis and, particularly, if they are not mentioned in the claims.

The present invention is explained below in greater detail in exemplary embodiments shown in the drawing.

### BRIEF DESCRIPTION OF THE DRAWINGS

FIG. 1 shows a schematic, axial longitudinal sectional view of a linear roller bearing on a shaft, according to a first exemplary embodiment of the present invention,

FIG. 2 shows a schematic sectional view along the line II-II in FIG. 1 of the present invention,

FIG. 3 shows a simplified, schematic side view of the linear roller bearing in FIG. 2 of the present invention,

FIG. 4 shows a schematic sectional view based on the view shown in FIG. 2 of a part of the linear roller bearing in FIG. 2, on a larger scale of the present invention,

FIG. 5 shows a schematic sectional view based on the view shown in FIG. 4 of a part of a linear roller bearing according to a second exemplary embodiment of the present invention,

FIG. 6 shows a schematic sectional view based on the view shown in FIG. 2 of a part of a linear roller bearing according to a third exemplary embodiment of the present invention,

FIG. 7 shows a schematic sectional view based on the view shown in FIG. 2 of a part of a linear roller bearing according to a fourth exemplary embodiment of the present invention,

FIG. 8 shows a schematic longitudinal view based on the view shown in FIG. 1 of a part of a linear roller bearing according to a fifth exemplary embodiment of the present invention,

FIG. 9 shows a schematic sectional view based on the view shown in FIG. 1 of a linear roller bearing according to a sixth exemplary embodiment of the present invention,

FIG. 10 shows a schematic sectional view based on the view shown in FIG. 2 of a part of a linear roller bearing according to a seventh exemplary embodiment of the present invention,

FIG. 11 shows a schematic view of a raceway element of the linear roller bearing in FIG. 10 of the present invention,

FIG. 12 shows a schematic view of a cage element of the linear roller bearing in FIG. 10 of the present invention,

FIG. 13 shows a schematic sectional view based on the view shown in FIG. 2 of a part of a linear roller bearing according to an eighth exemplary embodiment of the present invention.

### DESCRIPTION OF THE PREFERRED EMBODIMENTS

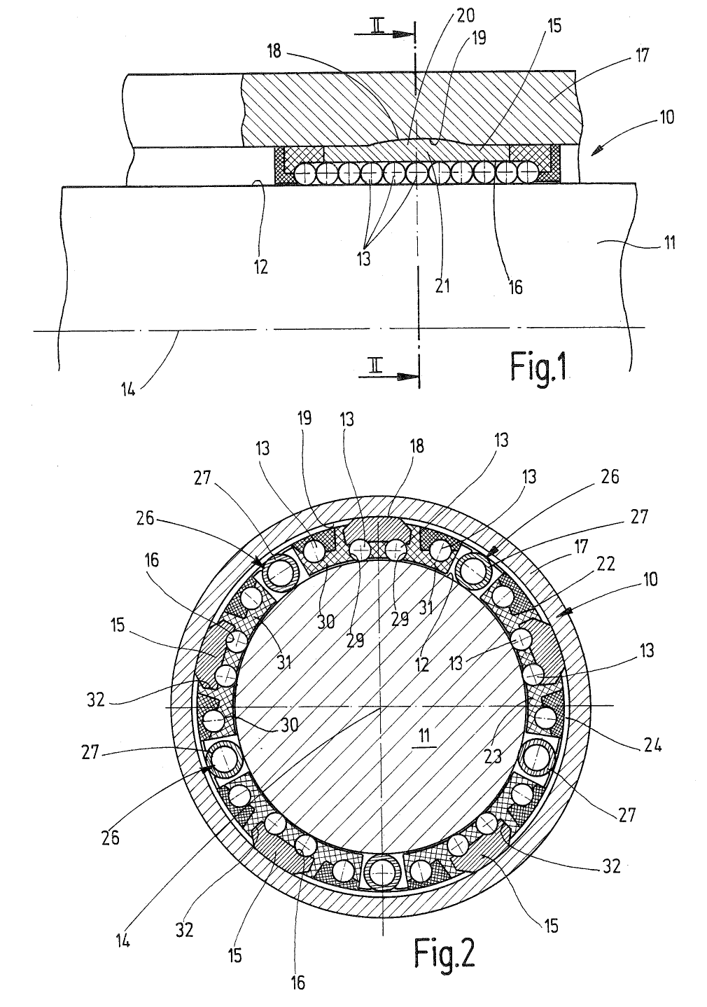

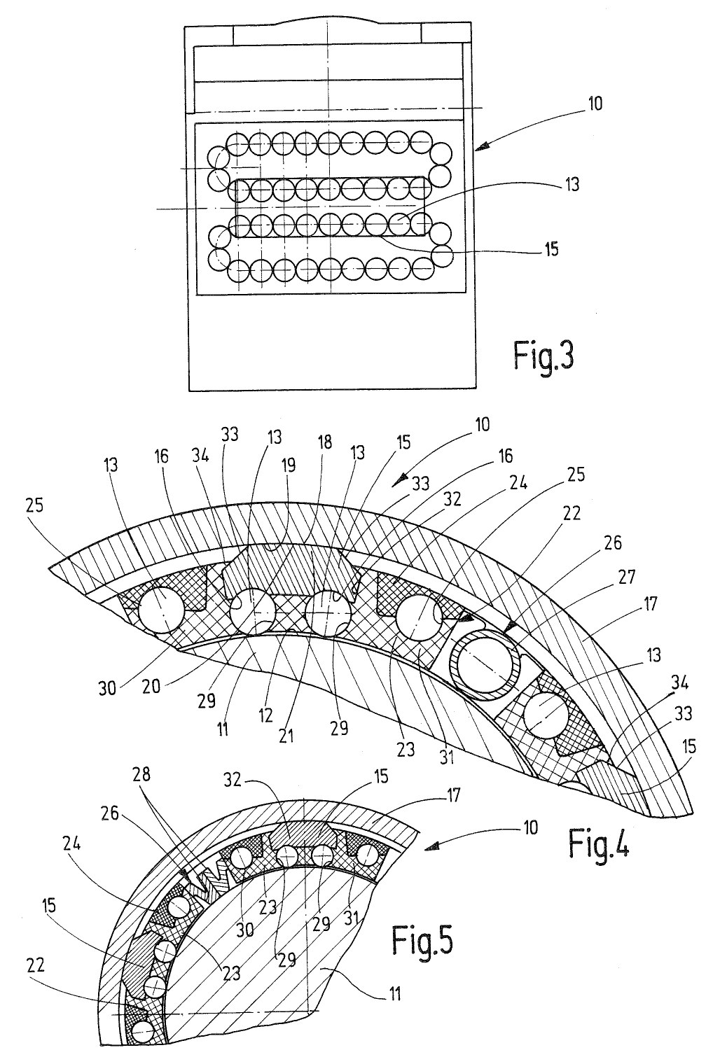

FIGS. 1 through 4 are schematic depictions of a linear roller bearing 10 according to a first exemplary embodiment, which is located on a profile 11 in the form of a shaft in this case. This profile has a circular cross section in this case, although it may have a different cross section. On its outer surface 12, profile 11 includes raceways for rolling elements 13 of linear roller bearing 10. Rolling elements 13 may have diverse designs. Advantageously, they are composed, e.g., of balls or cylindrical rollers or barrel-shaped rollers, or the like. Rolling elements 13 are located in individual rows of rolling elements, which extend essentially parallel to the longitudinally-extending central axis 14 of bearing 10 and to each other, and are distributed around a circle, as viewed in the cross section in FIG. 2. Raceway elements 15 are assigned to these rows of rolling elements—provided they are load-bearing rolling elements 13—each of which includes carrier raceway 16 of at least one row of rolling elements. Raceway elements 15 are grouped around central axis 14, preferably equidistantly from each other. In the exemplary embodiment shown, raceway elements 15 are designed with two rows and in a manner such that they include two carrier raceways 16, which are nearly parallel to each other.

Raceway elements 15 are enclosed in the circumferential direction by at least one connecting piece 17—on one longitudinal section, at least—such that raceway elements 15 bear via their outer surface 18 of the longitudinal section against a facing inner surface 19 of the at least one connecting piece 17.

A unique feature of the linear roller bearing 10 according to the first exemplary embodiment is that outer surface 18 and inner surface 19 are curved biaxially and thereby bear against each other in two dimensions. It is advantageous when the biaxial curvature of inner surface 19 has the same dimensions and shape as the curvature of outer surface 18. The biaxial curvature of inner surface 19 and outer surface 18 extends around a first axis that extends along and nearly parallel to central axis 14 of bearing 10, and, simultaneously, around a second axis that extends transversely to the first axis, at a right angle thereto in particular. The radius of curvature of the biaxial curvature around the first axis can differ from that around the second axis. It can be advantageous when, instead, the radius of curvature around the first axis is the same as that around the second axis. Advantageously, these are curvatures of circular segments. In this case, inner surface 19 and outer surface 18, which bear against each other in two dimensions, are curved nearly in the manner of a hemispherical dish. The at least one connecting piece 17 may include a concave receptacle 20—which includes biaxially curved inner surface 19—on its radially inward side. In conformance therewith, raceway elements 15 include—on the outside of at least one longitudinal section—a convexly projecting back 21, which includes biaxially curved outer surface 18. In another, not-shown exemplary embodiment, the design is reversed.

In that case, individual raceway elements 15 are provided, on outer side 18, with a concave receptacle that has a matching, recessed, biaxially curved outer surface 18, while the at least one connecting piece 17 includes—on its inner side—a radially inwardly projecting, convex back with a matching, biaxially curved inner surface.

Raceway elements 15 are movable relative to each other, specifically in the circumferential direction and/or in the radial direction relative to each other. Raceway elements 15 may be acted upon in the circumferential direction and/or in the radial direction by elastic or spring-action means. As a result, linear roller bearing 10 may be inserted into connecting piece 17 relatively quickly and easily such that convex back 21 engages radially in concave receptacle 20 via a form-fit connection. The elastic or spring-action means are so resilient in the circumferential direction and/or the radial direction once the raceway element structure has been inserted in connection part 17 that, due to convexly projecting back 21, raceway elements 15 are forced radially inward, and, when convex back 21 is aligned with concave receptacle 20, raceway elements 15 are acted upon in an elastic or spring-action manner such that convex back 21 engages radially in concave receptacle 20 via a form-fit connection, and raceway elements 15 are then captively held axially in a non-positive and/or form-fit manner inside connecting piece 17.

Due to biaxially curved inner surface 19 and outer surface 18, which bear against each other in two dimensions, raceway elements 15 may tilt around their longitudinal axis and transverse axis in a self-adjusting manner and become oriented on outer surface 12 of profile 11—on which the raceways are formed—such that loads are distributed on individual rolling elements 13 in a nearly constant manner. It is thereby ensured that, when profile 11 deflects, and/or if connecting piece 17 becomes deformed, the load is distributed on individual rolling elements 13 very evenly. Given that raceway elements 15 are movable relative to each other in the circumferential direction and/or in the radial direction, linear roller bearing 10 may be installed in the axial direction of profile 11. The outer diameter measured at the highest point on curved outer surface 18 is thereby reduced to the size of the inner diameter of the cylindrical part of connecting piece 17.

If, when linear roller bearing 10 is slid further into connecting piece 17, convex back 21 and concave receptacle 20 become aligned, the elastic or spring-action means cause raceway elements 15 to be pressed apart in the radially outward direction, and they are captively held in connecting piece 17 via the two-dimensional contact of inner surface 19 and outer surface 18. After profile 11 is inserted, the position of raceway elements 15 is fixed via profile 11 by widening in the radial direction, and, e.g., back 21 shaped like a hemispherical dish is accommodated in matching receptacle 20, which is also shaped like a hemispherical dish. When profile 11 is removed, raceway elements 15 remain in position, since they are prevented from falling out via the forces—acting in the radial and/or circumferential direction—of means 26 acting on raceway elements 15 elastically or with spring action, thereby also ensuring reliable deinstallation. It is clear that, after profile 11—outer surface 12 of which includes raceways for rolling elements 13—is inserted, raceway elements 15 and, therefore, entire linear roller bearing 10 may therefore not be displaced longitudinally, thereby ensuring axially secure positioning.

In deviation from the design shown, linear roller bearing 10 described may only include individual carrier raceways 16 that extend in parallel with each other and with central axis 14, along which individual rows of rolling elements roll forward and backward in the axial direction, without an endless circulation taking place with an additional return track and turnaround sections at the ends. A design of linear roller bearing 10 of this type is suited for use with short reciprocating paths in particular. This design also has the advantage that individual raceway elements 15 may orient themselves—independently of each other—on the assigned guide tracks on outer surface 12 of profile 11. Due to biaxially curved outer surface 18 and inner surface 19, individual raceway elements 15 are self-adjusting, thereby also ensuring that linear roller bearing 10 runs smoothly when rolling elements 13 roll along.

In the first exemplary embodiment shown in FIGS. 1 through 4, a cage element 22 is assigned to each raceway element 15. Cage element 22 has a divided design in this case, being composed of an inner cage element 23 and an outer cage element 24. Cage element 22 typically forms at least one part of the guide for rolling elements 13—which roll along in a closed row—in the region of raceway element 15, a return track 25 assigned to particular carrier raceway 16 and extending laterally thereto in the circumferential direction, and not-shown turnaround sections, which connect return tracks 25 at each end with assigned carrier raceway 16. One raceway element 15 is connected with one cage element 22 in each case. Cage elements 22 of two raceway elements 15 located next to each other in the circumferential direction are supported elastically in the circumferential direction via elastic means 26. Since raceway elements 15 are connected with cage elements 22, this elastic support acts via particular cage element 22 on raceway element 15. In a not-shown exemplary embodiment, these elastic means can be spring-action elements of cage elements 22, e.g., spring-action cantilevers, via which cage elements 22 bear against each other. In the example shown in FIGS. 1 through 3, profiled elements 27 with nearly tubular cross sections are provided as elastic means 26, and they are located between two adjacent cage elements 22 in the circumferential direction. In the example shown in FIG. 5, two adjacent, nearly V-shaped profiled elements 28 are provided as elastic means 28 in each intermediate space between two adjacent cage elements 22.

Radially inward cage element 23 that has one longitudinal slot 29—for each carrier raceway 16 of raceway element 15—for rolling elements 13, which extend radially through to particular carrier raceway 16 and roll along carrier raceway 16, and which includes sections 30, 31 that extend beyond carrier raceway 15 on both sides in the circumferential direction. Radially outer cage element 24 engages in the top of both sections 30, 31—which extend outwardly on both sides—and complete a particular return track 25. As shown, each raceway element 15 is accommodated in a longitudinal receptacle 32 of inner cage element 23 in a form-fit manner. Longitudinal receptacle 32 has a nearly U-shaped cross section; the walls on both sides may extend, e.g., slightly in the shape of a wedge, with the wedge tip pointing toward central axis 14. Each carrier raceway element 15 is accommodated in a form-fit manner in longitudinal receptacle 32 of inner cage element 23, and is overlapped radially and held in place via edge strips 34 of inner cage element 23, which overlap raceway element 15, preferably inclined surfaces 33 thereof.

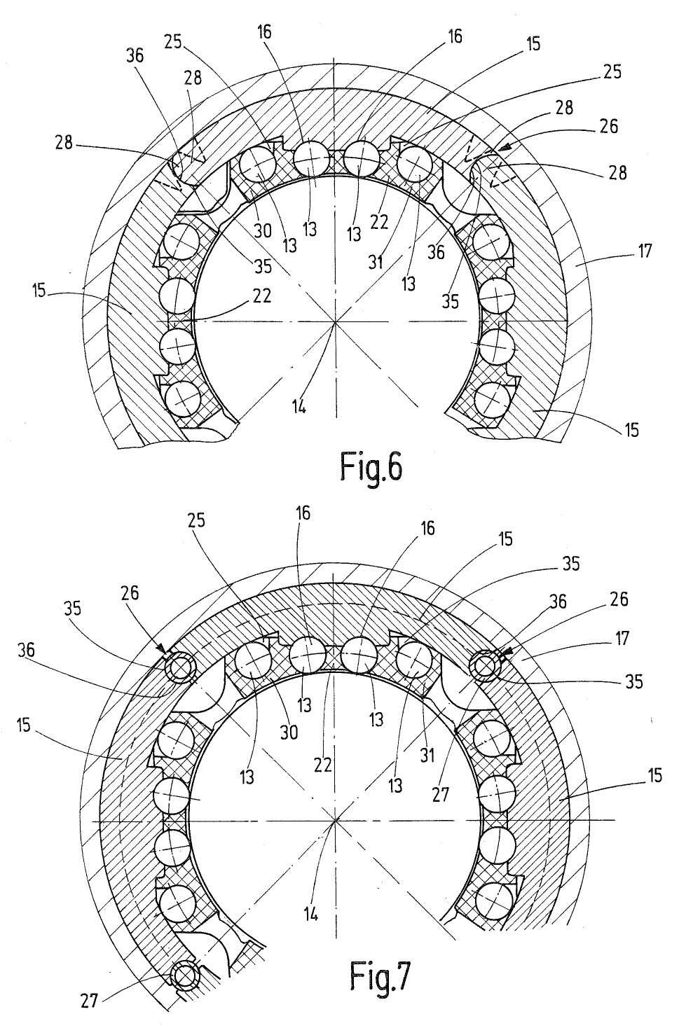

In the third exemplary embodiment, shown in FIG. 6, and in the fourth exemplary embodiment shown in FIG. 7, the same reference numerals are used for the components that correspond to the first exemplary embodiment. To avoid repetition, reference is hereby made to the description of the first exemplary embodiment. In these exemplary embodiments, cage element 22 has a one-piece design.

It is covered radially outwardly in the circumferential direction by an assigned raceway element 15. Particular raceway element 15—together with cage element 22—forms an assigned, adjacent return channel 25 for rolling elements for each carrier raceway. In these exemplary embodiments as well, individual raceway elements 15 are acted upon in the circumferential direction by elastic or spring-action means 26. According to FIG. 6, raceway elements 15 bear against each other in the circumferential direction. They may be supported in an elastically springy manner in this direction. Raceway elements 15 are provided—in the region of areas that adjoin each other in the circumferential direction—with profilings 35 on one side, and profilings 36 on the other side, the two profilings extending nearly parallel to central axis 14. Profilings 35, 36 are themselves elastic, and/or they accommodate elastically deformable means between them, as indicated, e.g., in FIG. 7, where elastic means 26 are placed between profilings 35, 36, which are in contact with each other.

It is understood that these additional elastic means 26 in FIG. 7 can also have a different design. In the exemplary embodiment shown in FIG. 6, one profiling 35 is designed as a convexly projecting channel, and the other, matching profiling 35 is designed as a concave channel. Other forms of intermeshing profilings lie within the framework of the present invention. Dashed lines in FIG. 6 also indicate that raceway elements 15 can instead be designed, in the region of adjoining ends, such that profiled elements 28 with nearly V-shaped cross sections can result, which are similar, e.g., to profiled elements 28 in FIG. 5, although every V-shaped profiled element is formed on one end of a raceway element 15, as a single-pieced part thereof.

In another, not-shown exemplary embodiment, raceway elements 15 and/or assigned cage elements 22 can be held together in the region of bilateral axial ends using elastic or spring-action means, which permit raceway elements 15 to deflect inwardly and outwardly. These means can be, e.g., annular springs placed radially inward and that exert outwardly directed spring forces.

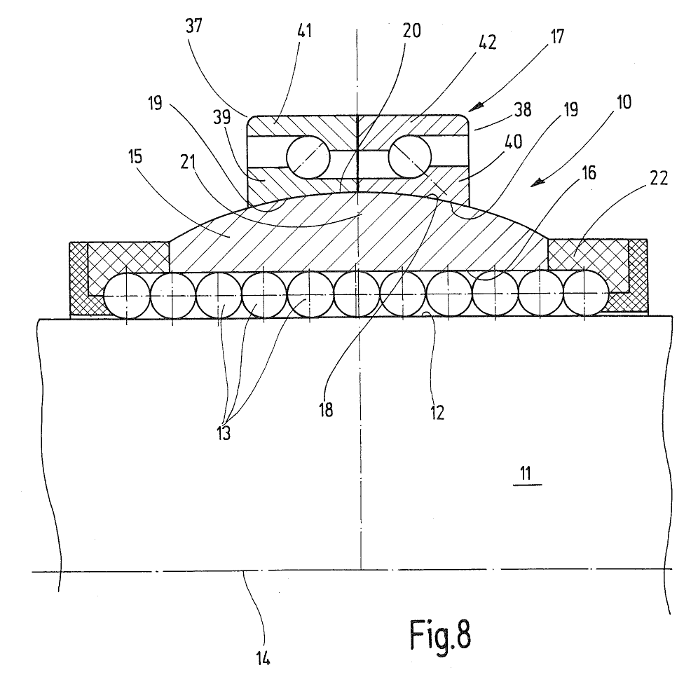

In the fifth exemplary embodiment, shown in FIG. 8, the same reference numerals are used for the components that correspond to the previous exemplary embodiments. To avoid repetition, reference is hereby made to the description of the previous exemplary embodiments.

Linear roller bearing 10 shown in FIG. 8 includes a connecting piece 17, which is composed of at least one roller bearing 37, e.g., a ball bearing, such as an angular ball bearing or the like. In the exemplary embodiment shown, two roller bearings 37, 38 are located axially next to each other. Every roller bearing 37, 38 includes an inner ring 39, 40 and an outer ring 41, 42. Each roller bearing 37, 38 can be divided, e.g., its inner ring 39, 40 can be divided. In conformance with biaxially curved outer surface 18 of each raceway element 15, the radially inwardly extending inner ring surface of each inner ring 39, 40 is designed as a biaxially curved inner surface 19, which bears against biaxially curved outer surface 18 of particular raceway element 15 in two dimensions.

As shown, when roller bearing 37, 38 is fixed in position three-dimensionally, linear roller bearing 10 may move relative to roller bearings 37, 38 and profile 11 in a self-adjusting manner, due to the spherical receptacle in roller bearings 37, 38. Inner rings 39, 40 of both roller bearings 37, 38 may be advantageously preloaded in the axial direction. Their biaxially curved inner surfaces 19 abut each other, as viewed in the direction of central axis 14. Roller bearings 37, 38 may be installed separately, and, in this manner, particular raceway element 15 with convex back 21 may be inserted in concave receptacle 20 formed by both roller bearings 37, 38 together. This position is secured by clamping inner rings 39, 40 together axially. This also allows linear roller bearing 10 to rotate with inner ring 39, 40, due to the minimal rolling friction of the rolling elements.

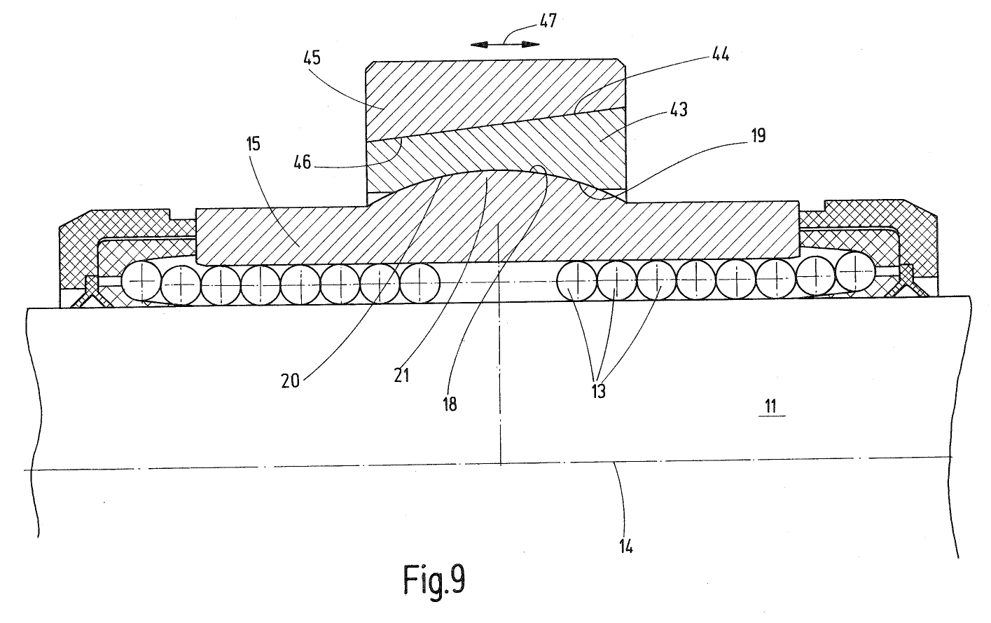

In the sixth exemplary embodiment, shown in FIG. 9, biaxially curved inner surface 19 is formed on the radially inwardly extending inner annular surface of a ring 43. Ring 43 has an outer conical surface 44, which extends diagonally relative to central axis 14. Ring 43 is enclosed by an outer ring 45, which rests on ring 43 via a conical surface 46 matched to conical surface 44, and which is retained in an axially displaceable manner to adjust ring 43 radially, as indicated by arrow 47. Ring 43 may be divided into two circumferential halves. It may also be divided in the radial direction. In this exemplary embodiment, depicted in FIG. 9, individual raceway elements 15 are therefore displaceable in the radial direction via the interaction of ring 43 and outer ring 45.

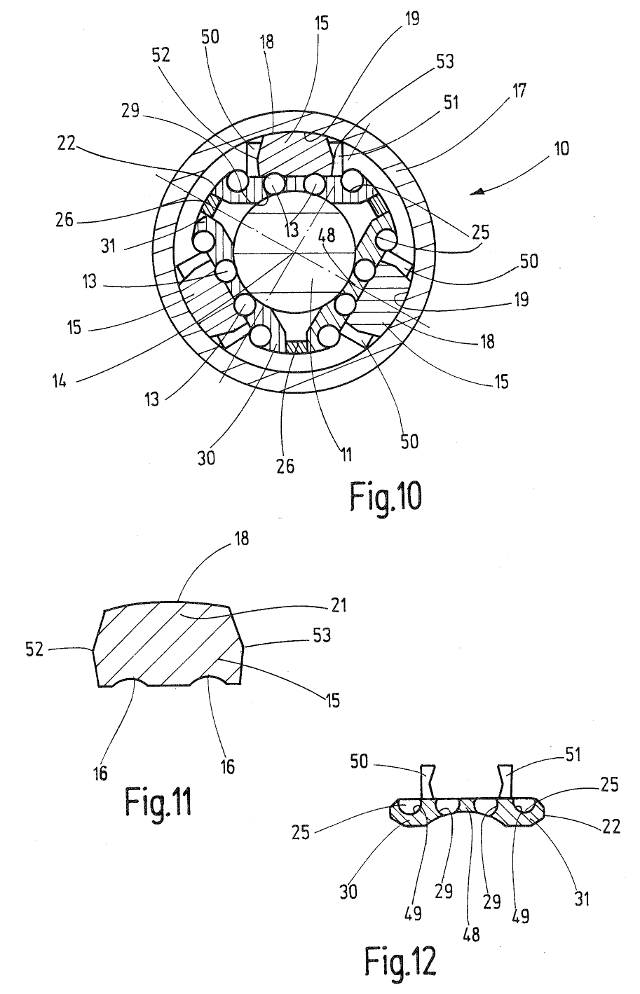

In the exemplary embodiment shown in FIGS. 10 through 12, certain parallels with the first exemplary embodiment are obvious. Cage element 22 has a one-piece design, however. It includes a center piece 48 with one longitudinal slot 29 per carrier raceway 16 for rolling elements 13, which extend radially across particular carrier raceway 16 and roll along carrier raceway 16. Sections 30, 32 extend outward in the circumferential direction on both sides of center piece 48 and include longitudinal grooves 49 that form return tracks 25. Longitudinal grooves 49 have a circumferential course greater than 90°—as viewed in the cross section—which prevents rolling elements 13—which are returning and are guided in longitudinal grooves 49—from falling out.

Particular raceway element 15 is connected with cage element 22 using a snap-in connection. To this end, cage element 22 includes clamping legs 50, 51, which extend upward from central piece 48 of cage element 22 and clamp onto raceway element 15 to connect particular raceway element 15 with cage element 22 such that two clamping legs 50, 51, which form a pair, laterally enclose one raceway element 15 in each case and secure it in position between them. Advantageously, two separate clamping leg pairs 50, 51 are provided along the longitudinal extension of a cage element 22, which extends in the direction of central axis 14. Clamping legs 50, 51 are elastic such that one raceway element 15 may be snapped into place between them, and raceway element 15 is held in place securely by clamping legs 50, 51. Particular raceway element 15 includes—as viewed in the cross section—nearly prismatic side regions 52, 53, which are designed with a slight, outwardly extending “V” shape. The insides of clamping legs 50, 51 facing side regions 52, 53 are formed to match side regions 52, 53.

Linear roller bearing 10 according to the seventh exemplary embodiment is particularly simple in design. Elastic or spring-action means 26 are located between cage elements 22 positioned next to each other in the circumferential direction. Means 26 may have diverse designs, e.g., they may be designed as hollow elements, strips with nearly V-shaped profiles, or the like.

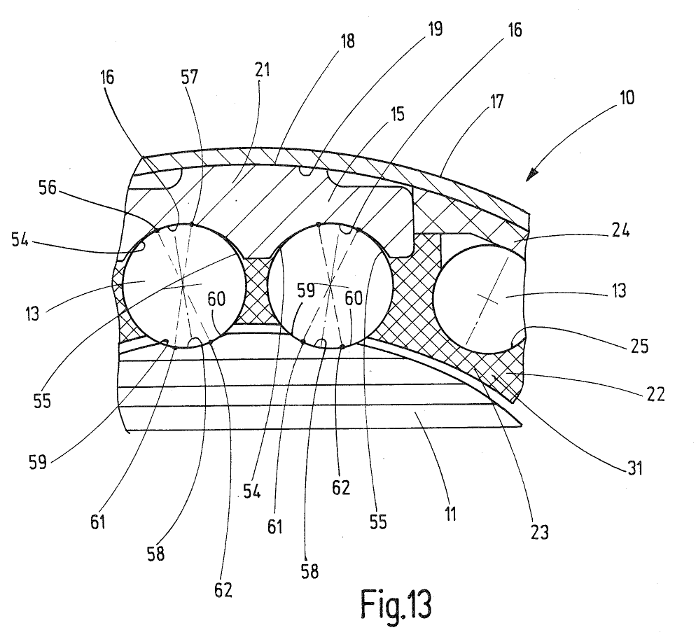

In the eighth exemplary embodiment of linear roller bearing 10, shown in FIG. 13, linear roller bearing 10 is penetrated by a profile 11, e.g., a shaft, on which raceways for rolling elements 13 are formed. The at least one carrier raceway 16 per raceway element 15 is composed—as viewed in the cross section—of two arc segments 54 and 55 having different radii. In this manner, a two-point bearing contact for spherical rolling elements 13 is formed on this at least one carrier raceway 16 in each case. The two points of this two-point bearing contact are labeled schematically with 56 and 57. As a result, the load-carrying capacity is nearly doubled in the region of particular carrier raceway 16.

In this case, the raceways of profile 11 provided for each carrier raceway 16 are designed as recessed longitudinal channels 58 in each carrier raceway 16. The raceway formed by particular longitudinal channel 58 for rolling elements 13 is composed—as viewed in the cross section—of two arc segments 59, 60 having different radii, forming two-point bearing contacts there for spherical rolling elements 13 on particular longitudinal channel 58. These two-point bearing contacts are labeled with points 61, 62, for clarity. This design results in a linear roller bearing 10, with which one carrier raceway 16 of raceway element 15—together with an assigned longitudinal channel 58 of profile 11—forms a four-point bearing contact for spherical rolling elements 13 between them. Back 21 of raceway element 15 is designed such that it can oscillate around the longitudinal axis. As a result, the load is distributed evenly between the left and right raceways, as shown in FIG. 13. Balls 13 therefore rotate around axes that are positioned at right angles to the connecting lines of the points of contact 56, 60 and 57, 59 of balls 13. Balls 13 may therefore roll without any geometric restrictions or slip.

In all of the exemplary embodiments, raceway elements 15 are made of metal, as are connecting piece 17 and profile 11. The cage element can be made of plastic.

Instead of the cylindrical sleeve shown, or in addition thereto, connecting piece 17 may also include at least one annular configuration, which encloses and radially supports carrier raceway elements 15 on at least one longitudinal section. This annular configuration may include at least one ring, on inner surface 19 of which raceway elements 15 bear via their outer surface 18 of the longitudinal section. Inner surface 19 of the at least one ring may be curved biaxially and thereby form concave receptacle 20. Corresponding, convexly projecting back 21 on outer surface 18 of particular raceway element 15 then interacts with convex receptacle 20 of the particular ring to provide spherical support. These conditions can also be kinematically reversed, in which case concave receptacle 20 is provided on outer surface 18 of raceway element 15, and convex back 21 is provided on the inner surface of the ring.

In another, not-shown exemplary embodiment, raceway elements 15 include outer surfaces 19, which are parallel to their carrier raceway 16. The ring that encloses raceway elements 15 also has a cylindrical inner surface, and it bears via this inner surface against the outer surfaces of raceway elements 15 to support them. The outer surface of the ring is curved biaxially, at least on one longitudinal section. This biaxially curved outer surface of the ring is enclosed by an outer ring, which includes an inner surface that is also curved biaxially, and via which the outer ring rests on the biaxially curved outer surface of the ring. In this exemplary embodiment, the spherical bearing is therefore formed by the annular configuration with an inner ring and an outer ring that surrounds it. Raceway elements 15 are enclosed by this annular configuration. A kinematic reversal is possible in this case, too, in which case the convexly projecting back is not provided on the ring, but rather on the inside of the outer ring, and the concave receptacle is not provided on the outer ring, but rather on the outside of the inner ring.

It will be understood that each of the elements described above, or two or more together, may also find a useful application in other types of constructions differing from the type described above.

While the invention has been illustrated and described as embodied in a linear roller bearing, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A linear roller bearing, comprising a plurality of raceway elements which are grouped around a central axis of the bearing; rows of rolling elements distributed around a circle, as viewed in a cross-section, and arranged essentially parallel to each other and to said central axis of the bearing; at least one connecting piece which encloses said raceway elements in a circumferential direction on at least one longitudinal section such that said raceway elements bear via an outer surface of said longitudinal section against a facing inner surface of said at least one connecting piece, wherein said inner surface and said outer surface are curved biaxially and bear against each other in two dimensions.

2. A linear roller bearing as defined in claim 1, wherein a biaxial curvature of said inner surface has same dimensions and shape as a biaxial curvature of said outer surface.

3. A linear roller bearing as defined in claim 1, wherein a biaxial curvatures of said inner surface and said outer surface extend around a first axis that extends along and substantially parallel to said central axis of the bearing and, simultaneously, around a second axis that extends transversely to said first axis at a right angle thereto.

4. A linear roller bearing as defined in claim 3, wherein a radius of curvature around said first axis is different from a radius of curvature around said second axis.

5. A linear roller bearing as defined in claim 3, wherein a radius of curvature around said first axis is a same as a radius of curvature around said second axis.

6. A linear roller bearing as defined in claim 1, wherein said inner surface and said outer surface, which bear against each other in two dimensions, are curved substantially in a manner of a hemispherical dish.

7. A linear roller bearing as defined in claim 1, wherein each of said raceway elements includes on an outside or on a radially inward side of said at least one connecting piece a concave receptacle which has said biaxially curved inner surface.

8. A linear roller bearing as defined in claim 1, wherein said at least one connecting piece includes, on an inside or said raceway elements include on an outside of said at least one longitudinal section, a convexly projecting back which has said biaxially curved inner surface.

9. A linear roller bearing as defined in claim 1, wherein said raceway elements are movable relative to each other.

10. A linear roller bearing as defined in claim 1, wherein said raceway elements are movable relative to each other in a direction selected from the group consisting of a circumferential direction, a radial direction, and both.

11. A linear roller bearing as defined in claim 1; and further comprising means selected from the group consisting of elastic means and spring-action means and operable in a manner selected from the group consisting of acting upon and capable of acting upon said raceway elements in a direction selected from the group consisting of a circumferential direction, a radial direction, and both.

12. A linear roller as defined in claim 11, wherein said means are so resilient once said raceway elements have been inserted in said connecting piece that, due to a convexly projecting back said raceway elements are forced radially inwards, and when said back is aligned with a convex receptacle, said raceway elements are acted upon by said means such that said convex back engages radially in said concave receptacle via a form-fit connection, and said raceway elements are captively held axially inside said connecting piece in a manner selected from the group consisting of a non-positive manner, a form-fit manner, and both.

13. A linear roller bearing as defined in claim 1, wherein said raceway elements are arranged in a manner selected from the group consisting of bearing against each other in a circumferential direction, being supported via elastic spring action, and both.

14. A linear roller bearing as defined in claim 1, wherein said raceway elements include profilings arranged in a manner selected from the group consisting of said profilings extending substantially parallel to said central axis of the bearing in regions that are adjacent to each other and bearing against each other on a circumference, said profilings being configured in a manner selected from a group consisting of said profilings being elastic themselves, said profilings accommodating elastically deformable means between them, and both.

15. A linear roller bearing as defined in claim 1; and further comprising cage elements which are assigned to said raceway elements, wherein elements selected from the group consisting of said raceway elements, said cage elements, and both are held together at their bilateral, axial end regions using means selected from the group consisting of elastic means and spring-action means, which permit said elements selected from the group consisting of said raceway elements and said cage elements to reflect in a direction selected from the group consisting of inwardly and outwardly.

16. A linear roller bearing as defined in claim 1, wherein said connecting piece is composed of at least one roller bearing provided with an inner ring and an outer ring, and a radially inwardly extending inner ring surface is designed as said biaxally curved inner surface, against which said raceway elements bear two-dimensionally via said biaxially curved outer surface.

17. A linear roller bearing as defined in claim 16, wherein said at least one roller bearing is a bearing selected from the group consisting of a ball bearing and an angular ball bearing.

18. A linear roller bearing as defined in claim 16, wherein said roller bearing is configured as a divided roller bearing.

19. A linear roller bearing as defined in claim 16, wherein said inner ring of said roller bearing is divided.

20. A linear roller bearing as defined in claim 16, further comprising another such roller bearing, so that there are two said roller bearings, said two roller bearings being located next to each other on said biaxally curved outer surface of said raceway elements and their biaxally curved inner surfaces of said two roller bearings abut each other in a direction of said central axis of the bearing.

21. A linear roller bearing as defined in claim 20, wherein said two roller bearings have inner rings that are preloaded axially.

22. A linear roller bearing as defined in claim 1; and further comprising a ring having a radially inwardly extending inner annular surface which forms said biaxially curved inner surface and an outer conical surface that extends diagonally relative to said central axis of the bearing; and an outer ring which encloses said ring and is seated on said outer conical surface of said ring via a matching conical surface and which is retained in an axially displaceable manner in order to displace said ring radially.

23. A linear roller bearing as defined in claim 1, wherein said raceway elements include two carrier raceways that are substantially parallel with each other.

24. A linear roller bearing as defined in claim 1; and further comprising a cage element which is assigned to each of said raceway elements and forms at least one part of a guide for the rolling elements which roll along in a closed row in a region of said raceway element, a return track assigned to said carrier raceway, and turnaround sections which connect said carrier raceway and said return tracks and wherein said raceway elements are connected with said cage elements.

25. A linear roller bearing as defined in claim 24; and further comprising elastic means via which said cage elements of said two raceway elements located next to each other in a circumferential direction are supported elastically in said circumferential direction.

26. A linear roller bearing as defined in claim 25, wherein said elastic means are configured as means selected from the group consisting of spring-action elements of said cage elements, elastically deformable means located between said cage elements, and both.

27. A linear roller bearing as defined in claim 24, wherein each of said cage elements has a divided design and a radially inner cage element that has one longitudinal slot for each carrier raceway of said raceway element for said rolling element, which extend radially across a particular one of said carrier raceways and rolls along said carrier raceway, and which includes sections that extend beyond said carrier raceway on both sides, in a circumferential direction.

28. A linear roller bearing as defined in claim 27, wherein said divided cage elements include a radially outer cage element which engages in a top of bilaterally projecting sections of said inner cage element, forming a return track.

29. A linear roller bearing as defined in claim 27, wherein each of said raceway elements is accommodated in a form-fit manner in a longitudinal receptacle of said radially inner cage element and is overlapped radially and held in place via edge strips of said inner cage element, which overlap said raceway element.

30. A linear roller bearing as defined in claim 29, wherein said edge strips of said inner cage element overlap inclined surfaces of said raceway element.

31. A linear roller bearing as defined in claim 1; and further comprising elastically deformable means which form profile elements with cross-sections shaped in a manner selected from the group consisting of substantially “V” and a tube and located in a circumferential direction between two adjacent elements selected from the group consisting of cage elements, carrier elements, and both.

33. A linear roller bearing as defined in claim 1; and further comprising a cage element configured as a single piece and including a center part with one longitudinal slot per carrier raceway for said rolling elements, which extend radially across a particular one of said raceways and rolls along the carrier raceway, said cage element also including sections that extend away from both sides of said center part in a circumferential direction, said sections including longitudinal grooves that form return tracks and have a circumferential extension that is greater than 90°, to prevent said rolling elements from falling out.

34. A linear roller bearing as defined in claim 33, wherein said raceway element is connected with said cage element using a snap-in connection.

35. A linear roller bearing as defined in claim 34, wherein said cage element includes clamping legs that project upwardly from said center part and clamp onto said raceway element to connect said raceway element with said cage element.

36. A linear roller bearing as defined in claim 35, wherein said clamping legs include two clamping leg pairs that are separated in a longitudinal direction.

37. A linear roller bearing as defined in claim 35, wherein said raceway element has substantially prismatic side regions, as viewed in a cross-section, on which said clamping legs grip in a form-fit manner.

38. A linear roller bearing as defined in claim 1, wherein said raceway element has at least one carrier raceway which is composed, as viewed in a cross-section, of two arc segments having different radii, forming two-point bearing contacts for said rolling elements which are spherical rolling elements, on at least one of said carrier raceways.

39. A linear roller bearing as defined in claim 38; and further comprising a profile which includes raceways for the rolling elements, said raceways being provided for each carrier raceway and configured as longitudinal channels which are composed, as viewed in a cross-section, of two arc segments having different radii, forming two-point bearing contacts for said rolling elements which are spherical rolling elements on a particular one of said longitudinal channels.

40. A linear roller bearing as defined in claim 39, wherein said profile is configured as a shaft.

41. A linear roller bearing as defined in claim 38, wherein one carrier raceway of said raceway element together with an assigned one of said longitudinal channels of said profile, form a four-point bearing contact for said rolling elements, which are spherical rolling elements, between them.

42. A linear roller bearing as defined in claim 39, wherein at least one of elements selected from the group consisting of raceway elements, the profile, a connecting part, and a combination thereof is composed of metal.

43. A linear roller bearing as defined in claim 42, further comprising a cage element assigned to each of said raceway elements and composed of plastic.

44. A linear roller bearing, comprising a plurality of raceway elements which are grouped around a central axis of the bearing; rows of rolling elements distributed around a circle as viewed in a cross-section and extending substantially parallel to each other and to said central axis of the bearing; and at least one annular configuration which includes and radially supports said raceway elements on at least one longitudinal section, with at least one ring, against an inner surface of which said raceway elements bear via their outer surface on said longitudinal section, as defined in claim 1, wherein at least one surface selected from the group consisting of said inner surface and said outer surface of said ring is curved biaxially.

45. A linear roller bearing as defined in claim 44, wherein said raceway elements have outer surfaces that are parallel to their carrier raceway, and said ring that encloses it bears via its cylindrical inner surface against said outer surfaces, and said ring is enclosed by an outer ring on its biaxially curved outer surface, said outer ring having a matching biaxially curved inner surface, via which said outer ring sits on said biaxially curved outer surface of said ring, or kinematicaly vice versa.
